(19) United States
(12) Patent Application Publication
(10) Pub. No.: US 2009/0129070 A1
(43) Pub. Date: May 21, 2009

(54) METAL HALIDE LAMP AND LIGHTING DEVICE USING THEREWITH

(75) Inventor: Takayuki Wajata, Ehime-ken (JP)

Correspondence Address: BANNER & WITCOFF, LTD., 1100 13th STREET, N.W., SUITE 1200, WASHINGTON, DC, 20005-4051, US

(73) Assignee: Harison Toshiba Lighting Corporation, Imabari-shi (JP)

(21) Appl. No.: 11/994,619

(22) PCT Filed: Jul. 5, 2006
(86) PCT No.: PCT/JP2006/313374

§ 371 Date: Dec. 15, 2008

(30) Foreign Application Priority Data
Jul. 5, 2005 (JP) 2005-195671

(51) Int. Cl. F21V 15/01; H01J 17/04

(52) U.S. Cl. 362/217.1; 313/633

(57) ABSTRACT

A metal halide lamp comprises a translucent air tight vessel (1) having an arc tube section (11) forming a discharge space (13) and sealing portions (121, 122) formed at the both ends thereof, a discharge medium with which the discharge space is filled, and a pair of electrodes (31, 32) projecting into the discharge space. The discharge medium is composed of a metal halide and rare gas and essentially containing no mercury. The pair of the electrodes is composed of tungsten containing thorium oxide. Protrusions (311, 312) are formed respectively, on the pair of electrodes and arc is formed between them when the metal halide lamp is operated.

### TECHNICAL FIELD

The present invention relates to metal halide lamp used for headlights of motorcars or the like and to lighting device using the metal halide lamps.

### BACKGROUND TECHNOLOGY

Metal halide lamp enclosing no mercury is known and is disclosed in Japanese Unexamined Patent Application Publication No. 2005-142072. The lamp is provided with an airtight vessel having a discharge space of 0.1 cc or less and sealing portions on the both ends. The lamp is also provided with a pair of electrodes each of which has nearly column-shaped end portion and nearly column-shaped shaft portion formed on the end portion, wherein the diameter R (mm) of the end portion is 0.30≦R≦0.40, wherein the diameter r (mm) of the shaft portion is 0.25≦r≦0.30, and wherein R>r, The end portions are arranged and sealed at the sealing portion so as to face each other by an inter electrode distance of 5 mm or less in the discharge space of the air tight vessel. A discharge medium containing metal halide and rare gas is also enclosed inside the discharge space of the airtight vessel containing essentially no mercury. The lamp is lighted with a bulb wall load of 60 (W/cm²) or higher. It is known that there is a problem of flickering in such metal halide lamps containing no mercury.

It is described in Japanese Unexamined Patent Application Publication No. 2002-110091 that containing electron-emitting material such as thorium oxide in electrode can inhibit the flickering problem. In Japanese Unexamined Patent Application Publication No. 2002-110091, it is disclosed that an electrode doped with electron emitting material such as thorium oxide is used in high-pressure discharge lamp containing mercury. It is presumed that using similar electrode in metal halide lamp containing no mercury is also effective for preventing the flickering. However, it became clear that preventing flickering for a long period is difficult in metal halide lamp containing no mercury, even when the electrode is doped with thorium oxide. It is speculated that the thorium oxide is not supplied enough and smoothly during long-term use of the lamp because the electrode temperature becomes so high during lighting that the thorium oxide is accelerated to disappear in lamps containing no mercury. Therefore, increasing of the content of thorium oxide may be proposed to supply the lamp with thorium oxide smoothly for a long period. However, increasing of the thorium oxide tend to turn a color of the light emitting tube into milky, which decreases light flux of the lamp.

In order to resolve the above-mentioned problems, the inventers have performed a number of tests. As the result, it has found that an electrode containing thorium oxide and having a protrusion at a portion where arc is formed makes a position of arc stable for a long period even when thorium oxide content is low and thus the flickering is effectively prevented from occurring.

Thus one of the objects of the present invention is to supply a metal halide lamp capable of suppressing the flicker generation for a long period containing even a small amount of electron emitting substance in metal halide lamp using electrode material containing electron emitting material and enclosed with no mercury.

### DISCLOSURE OF THE INVENTION

A metal halide lamp according to the present invention includes a translucent and airtight vessel having a light emitting tube portion forming a discharge space and sealing portions formed on the both ends of the light emitting tube portion, a discharge medium composed of metal halide and rare gas enclosed in the discharge space containing essentially no mercury and, and a pair of electrodes the base end portions of which are sealed in the sealing portion and the top end portions of which are facing to each other in the discharge space; wherein the pair of electrodes are composed of tungsten containing electron emitting material, and at least on one of the electrode a first protrusion is formed on an end portion where arc is generated while lighting.

Further, the lighting device according to the present invention includes a main body of the lighting device, a metal halide lamp located inside the main body of the lighting device, and a lighting circuit connected electrically with the metal halide lamp, wherein the metal halide lamp includes a translucent air tight vessel having a light emitting tube portion forming a discharge space and sealing portions formed on both ends of the light emitting tube portion, and a discharge medium composed of metal halide and rare gas enclosed in the discharge space containing essentially no mercury, and a pair of electrodes the base end portions are sealed in the sealing portion and the top end portions are facing to each other in the discharge space, and wherein the pair of electrodes are composed of tungsten containing electron emitting material, and a first protrusion is formed on an end portion of at least one of the electrodes where arc is generated while lighting.

According to the present invention, generation of fluctuation can be suppressed for along period in the metal halide lamp having an electrode composed of electron emitting material and containing essentially no mercury and with even a small amount of electron emitting material.

### BRIEF DESCRIPTION OF THE DRAWINGS

FIG. 1 is a side view showing a overall configuration of a metal halide lamp according to a first embodiment of the present invention.

FIG. 2A is an enlarged side view of the electrode shown in FIG. 1.

FIG. 2B is an enlarged front view of the electrode shown in FIG. 1.

FIG. 3 is a partial enlarged view of the metal halide lamp shown in FIG. 1.

FIG. 4 is a table listing good-quality rates with or without the protrusion on the top of the electrode.

FIGS. 5A and 5B are figures for explaining the criteria for judging of generation of the flickering in FIG. 4.

FIG. 6A is a table and FIG. 6B is a graph for explaining the relation between thorium oxide content and luminance keeping ratio in the electrode of the metal halide lamp according to the present invention.

FIG. 7 is an enlarged view of the electrode used in a second embodiment of the present invention.

FIGS. 8A and 8B are enlarged views of the electrode used in a third embodiment of the present invention.

FIG. 9 is a table listing good product rates with or without the protrusion on the top of the electrode and bottom of the metal halide lamp according to the present invention.

FIG. 10 is a view showing an overall construction of the lighting device according to a fourth embodiment of the present invention.

FIG. 11 is a block diagram explaining a lighting circuit used in the fourth embodiment of the present invention.

### DETAILED DESCRIPTION OF THE INVENTION

### First Embodiment

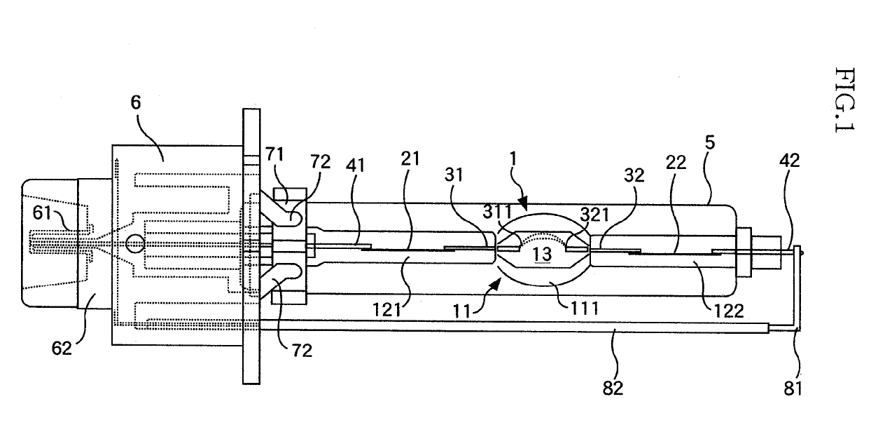

Hereinafter, a metal halide lamp according to an embodiment of the present invention will be explained referring to the figures. FIG. 1 is a side view showing an overall configuration of a metal halide lamp, which is a first embodiment of the present invention.

An air tight vessel 1 is made of a material with fire resistance which withstands high temperature during a discharge lamp is lighted and with a translucency which enables generated light to transmit through with as low loss as possible. The vessel 1 is, made of fused quartz, for example. A light emitting tube portion 11 is formed at a nearly central portion of the airtight vessel 1 having a nearly oval sectional shape along the axial direction of the airtight vessel 1. Sealing portions 121, 122 having a plate shape are formed on both ends of the tube portion 11. Inside the light emitting tube portion 11, a discharge space 13 is formed having a nearly cylindrical central portion and taper-shaped ends on both side of the central portion. It is preferable that the volume of the discharge space 13 is 0.1 cc or less in discharge lamp of short arc type, and the inner volume of the discharge space is 0.01 cc to 0.04 cc when especially specified as for automobile use.

Metal halides and rare gases are enclosed in the discharge space 13 as a discharge medium. As metal halides, halides of sodium, scandium which act as a light emitting medium for generating mainly visible light, halide of zinc which acts as lamp voltage formation medium instead of mercury, and indium halide aiming to improve luminescence chroma during lighting are enclosed. Further, cesium iodide, tin iodide etc. can be enclosed depending on various purposes. Here, as a halide combined with iodine, having low reactivity in halides is most suitable among the halide combined with metals described above. However, the metal, which is combined with halide, is not limited to iodine, but bromine or chlorine may be used, and a combination of the metal with a plurality of halides may be used.

As a rare gas, xenon is enclosed which has a high luminous efficiency at a start up time for mainly acting as a start up gas. It is preferable that the pressure of xenon is 10 to 13 atm. As a rare gas, xenon is most Preferable, however, neon, argon, krypton or a combination of them may be used.

Here, mercury is not essentially contained in the discharge space 13. The sentence “mercury is not essentially contained” means that mercury is not contained at all, or is permitted contained less than 2 mg per 1 cc, preferably 1 mg per 1 cc or less. The mercury content less than 2 mg permitted in the present embodiment is predominantly less, compared with the content of mercury of 20 to 40 mg per 1 cc or in some cases equal to or more than 50 mg in conventional short arc type metal halide lamps containing mercury, so that it can be said that mercury is not essentially contained in the lamp according to the embodiment of the present invention.

Metal foils 21, 22 made of molybdenum, for example, are sealed in the sealing portions 121, 122. Flat surfaces of the metal foils 21, 22 are parallel with the flat surfaces of the sealing portions 121, 122. On one end of metal foil 21, 22, stepped electrodes 31, 32 are connected by welding. The leading end portions of the stepped electrodes 31, 32 have larger diameter than the base end portions. The electrodes 31, 32 are composed of thoriated tungsten the main component of which is tungsten doped with thorium oxide of 0.1 wt. % to 1.2 wt. %. Other than the thorium oxide cerium oxide, lanthanum oxide or yttrium oxide may be used as the electrode emitting material contained in the electrodes 31, 32. However, thorium oxide is most preferable in the embodiment according to the present invention in which temperature rises high during operation, because thorium oxide can be used under high temperature.

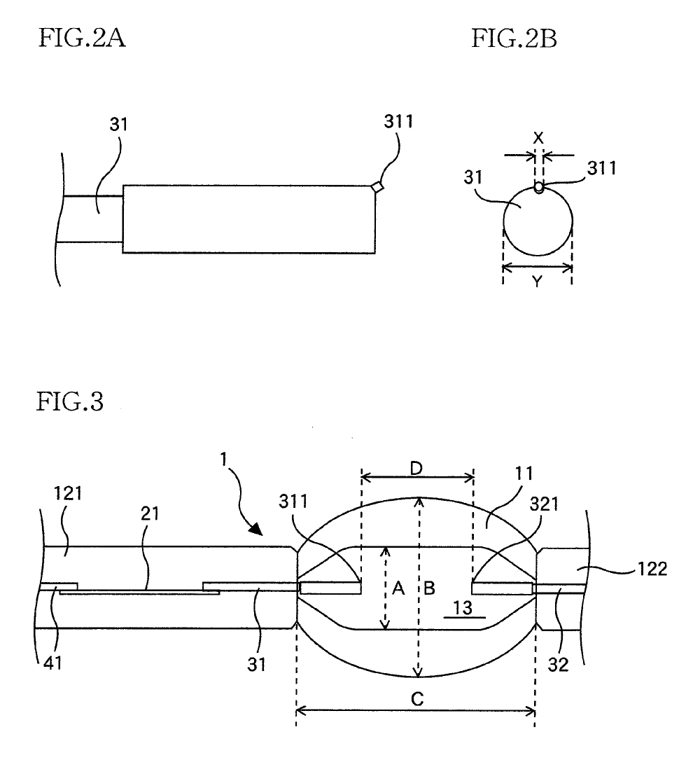

First protrusions 311, 321 are formed at a position on each leading end portion of the electrodes 31, 32, where arc is generated, as shown in FIG. 2-A and FIG. 2-B. A distance between the electrodes substantially decides the position where arc is generated. For example, when the distance between the electrodes is rather short, about 2.0 mm for example as in the case of metal halide lamp for projector use, the position is approximately at a center of an end surface. While, the protrusions may be formed on the upper portion of the end surface when the distance between the electrodes is longer than 3.0 mm as in the case of metal halide lamps for motorcars. The reason is that the arc is influenced less by buoyancy or by convection of discharge medium, when the distance between the electrodes is short, and is influenced more when the distance between the electrodes is long. In the embodiment of the present invention, the distance between the electrodes is assumed to be longer than 3.0 mm, and the first protrusions 311, 321 are formed on the upper end of the end surface of the electrodes 31, 32.

Here, the distance between the electrodes is preferably 5 mm or less and 3.5 mm to 5.0 mm is more preferable in the actual distance in the discharge space 13. The distance between the protrusions 311, 321 is defined as the distance between the electrodes in the present embodiment, because the protrusions 311, 321 portions are located on the extreme ends of the electrodes.

The dimension X of the protrusions 311, 321 in the first embodiment is preferably 20% or less of the diameter Y of the end portion of the electrodes 31, 32. The reason is that temperature of the protrusion is hard to rise if X is larger than 20%, which is unfavorable for inhibiting the flickering as described later.

Either one of the following processes are employed as a method for forming the electrode with the protrusion. For example, after each of electrode and protrusion is formed separately, they are combined together, or an electrode with a large diameter is processed with cutting work. When each of the electrode and the protrusion is formed separately, both are made of essentially the same electrode material.

Each end of outer lead wires 41, 42 made of molybdenum is connected with the other end of the metal foil 21, 22, by welding etc. Each opposite end of the outer lead wires 41, 42 is extended outside of the sealing portion 121, 122.

A tubular outer tube 5 is provided outside the airtight vessel 1 having parts mentioned above, so as to cover the most of parts of the airtight vessel 1 along the tube axis. The tubular outer tube 5 is produced by adding quartz glass with at least one or a plurality of such oxides as titanium, cerium, aluminum, potassium, barium etc. to provide it with translucency and ultraviolet cutoff character. This outer tube 5 is closed by welding at further end portions than sealing portion 121, 122.

Here, a space encapsulated by the airtight vessel 1 and the outer tube 5 may be filled with inert gas such as nitrogen or argon may be enclosed or may be vacuum atmosphere. Thus, the space can be maintained at low humidity or no humidity. When argon is enclosed, the heat conductivity in the space becomes low compared with the case where nitrogen is enclosed. As the result, temperature of the light emitting tube 11 can be kept high, so that the luminous efficiency can be improved.

A socket 6 is coupled with the outer tube 5 enclosing airtight vessel 1 at an end where the sealing portion 121 is provided. This coupling is made by pinching a metal band 71 loaded around the outer tube 5 with four metal tongue-shaped pieces 72 provided on and extended from the socket 6. A metal terminal 61 is provided on the bottom of the socket 6 for supplying power from lighting circuit and is connected with an outer lead wire 41. Another metal terminal 62 is provided on outer surface of the socket 6 and is connected with another outer read wire 42 extending outside of the sealing portion 121 via power feeding terminal 81. Major part of the power-feeding terminal 81, which is nearly parallel to the tube axis, is covered with an insulating tube 82 composed of ceramics and the like.

The metal halide lamp thus constructed is arranged horizontally and is lighted with a power of about 35 W in a stable period. However it is lighted with a power of about 75 W, twice as high power of that of the stable period, in a start-up period in order to accelerate the initial rise of luminous flux.

FIG. 3 is an enlarged illustration for explaining such a specific construction of the metal halide lamp in FIG. 1 as stated bellow.

Discharge vessel 1: composed of fused quartz,
Volume of discharge space 13=0.027 cc,
Inner diameter A=2.6 mm, outer diameter B=6.3 mm,
Longitudinal spherical length C=7.8 mm,
Metal halide=NaI=0.36 mg, ScI₃=0.22 mg, ZnI₂=0-0.06 mg, InBr=0.002 mg
Rare gas: xenon=11 atm
Mercury: 0 mg
Metal foil 21, 22: composed of molybdenum,
Electrode 31, 32: composed of thoriated tungsten, Diameter of leading edge=0.38 mm
Diameter of base edge=0.30 mm
Distance between the electrodes, D=3.7 mm

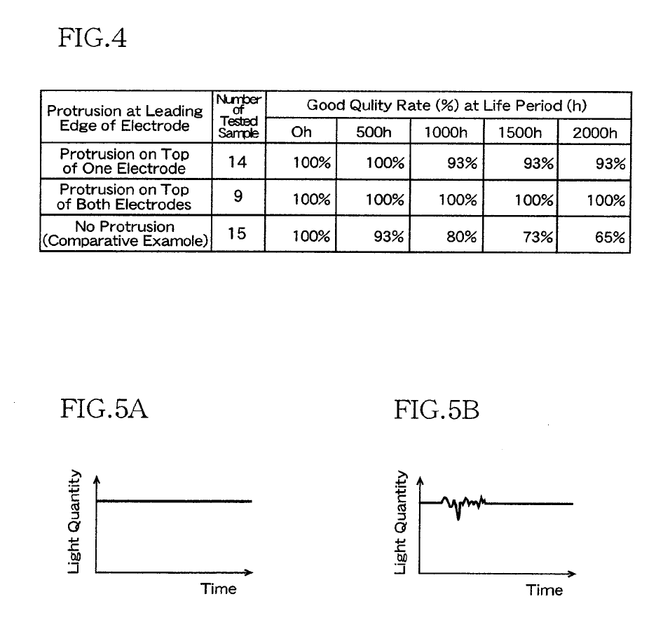

FIG. 4 is a table listing good-quality rates with respect to the flickering during a life period in the lamp having a specification shown in FIG. 3 when a protrusion is formed on the leading edge of the electrode. As comparative examples, a lamp in which one protrusion is formed on the top of the leading edge of one electrode in a pair of electrode, a lamp in which protrusions are formed on the top of the leading edges of both electrodes and a lamp in which protrusions are not formed at all are used for tests.

The test performed was a blinking test of EU 120 min. mode, which is a life test condition of a metal halide lamp for automobile headlamps specified by Japan Electric Lamp Manufacturing Association. The lamp is judged as a defective one when_the light quantity became unstable as shown in FIG. 5A and FIG. 5B. Here, content of thorium oxide was 0.5 wt % in the all lamps under test.

As it is clear from the results, it can be seen that the lamp provided with the protrusions inhibits the generation of flickering for longer period than the lamp without the protrusion. Further, the capability of inhibiting the flickering is higher when protrusions are provided on both electrodes.

The reason is assumed as follows. At first, on a initial stage of lighting, generation of flickering is inhibited by the common structure that both electrodes are doped with thorium oxide. However, in the electrode without protrusions, good-quality rate is decreasing after 500 hours or more of lighting period. It is assumed that the reason is related to degradation of electron emission capacity owing to the consumption of thorium oxide.

The reason is explained in detail as follows. In a metal halide lamp used for headlamps of automobile, a starting point of an arc, i.e. so-called an arc spot is formed on an end portion of the electrode when the lamp operation is moved into a stable period lighted at a rated power (about 35 W) from a start-up period lighted at a power of twice as high as the rated power (about 75 W). At that time, in the electrode of comparative example without protrusion, temperature rise of the end portion of the electrode is slow during lighting because the volume (heat capacity) of the end portion of the electrode where the arc spot is formed is large. As the result, the arc spot becomes movable and flicker is generated when the thorium oxide in that portion is consumed during life even though the arc spot position is stable at the initial stage of lighting, because the temperature difference between the portion where arc spot is formed and the other portion of the electrode becomes low, when the content of thorium oxide is less than 1.0 wt. % as in the comparative sample.

On the other hand, the arc spot is formed at the protrusion on the leading end of the electrode in the present embodiment. The temperature of the protrusion is maintained high during lighting, because the diameter of the protrusion is small compared with the diameter of the electrode. Therefore, the temperature difference between the protrusion where arc spot is formed and the other portion of the electrode is kept high. Thus, the position of the arc spot can be kept stable for a long period and the flickering can be prohibited during the life of the lamp even when the thorium content is less than 1.0 wt. %.

Thorium oxide has a tendency that it is apt to diffuse as the temperature difference is increasing. Here, thorium oxide is scattered in the entire electrode in the electrode doped with thorium oxide. The thorium oxide disappears in the vicinity of the position where the arc spot is formed when the lamp is lighted. If the thorium oxide is easy to be diffused, depletion of thorium oxide is restrained in the vicinity of the position which is advantageous for flickering prevention. That is, the thorium oxide is supplied from the other portion of the electrode when the thorium oxide is disappeared at the protrusion, because the electrode with protrusion has high temperature difference between the protrusion where arc spot is formed and the other portion of the electrode. Therefore, the flickering can be restrained for a long period though the doping content of thorium oxide is small.

An advantage is obtained that a lamp provided with a protrusion on the upper portion of the electrode shows a low starting voltage compared with a lamp without protrusion showing an improved start-up characteristics. To be more precise, average voltage needed for starting-up was 16.8 kV in a lamp having an electrode without protrusion. It was 15.3 kV in a lamp with protrusion formed on the upper portion of one of the electrodes, and was 14.9 kV in a lamp with protrusions formed on the upper portions of both electrodes. It is understood that the starting-up voltage became low, because the electric field was concentrated at the upper protrusions 311, 321, and dielectric breakdown becomes easy to occur in the discharge space 13, when the voltage is applied.

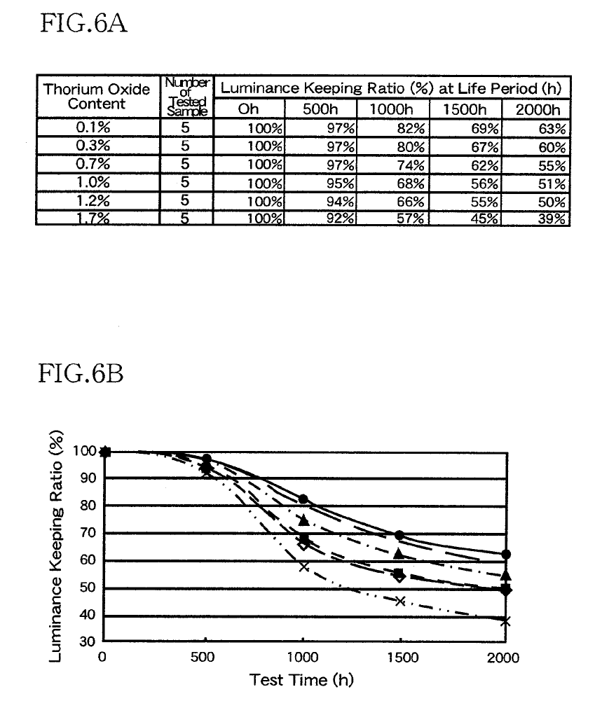

In the next, change in characteristics depending on the content of the thorium oxide will be explained. FIG. 6-A and FIG. 6-B are diagrams for explaining the change in a luminance keeping ratio during a life period depending on the thorium oxide content. The test is a blinking test of EU 120 min. mode similar to that shown in FIG. 4. The luminance was measured with a luminance meter via a slit having a diameter of 1 mm at the upper portion and at nearly central portion of the light emitting tube 11.

This test reveals the extent of blackening and whitening at the upper portion of the light emitting tube 11, and the extent of degradation of transmission factor owing there to. The results show that all the lamps containing thorium oxide decreased in the luminance keeping ratio_from 500 hours and the decreased more rapidly afterwards as the thorium oxide content becomes high. The reason is that the thorium oxide in the electrode is decomposed into thorium and oxygen and is emitted during the lighting periods, which react with the glass together with scandium iodide in the discharge medium generating the whitening. Further, the reason why the decrease in the luminance keeping ratio becomes great as the thorium oxide content becomes high is that thorium and oxygen, which cause the whitening, are excessively generated easily. Therefore, the content of thorium oxide is preferable in the range from 0.1 wt. % to 1.2 wt. %, in which the decrease of the luminance keeping ratio is relatively small and the flickering can be inhibited for a long period.

Thus, according to the present embodiment, in which a metal halide lamp having an electrode with electron emitting substance as its material and enclosing no mercury, the flickering can be prevented from generating for a long period by forming protrusions 311, 321, even with a small amount of the electron emitting substance.

Further, load to the electrodes 31, 32 and to the lighting circuit can be reduced because the start-up voltage is made low by the protrusions 311, 321.

Further, the whitening can be prevented from generating as much as possible and luminance keeping ratio as well as illumination intensity keeping ratio can be kept at an excellent value, contributing to an improvement of environmental problems, because the amount of thorium oxide used can be reduced.

### Second Embodiment

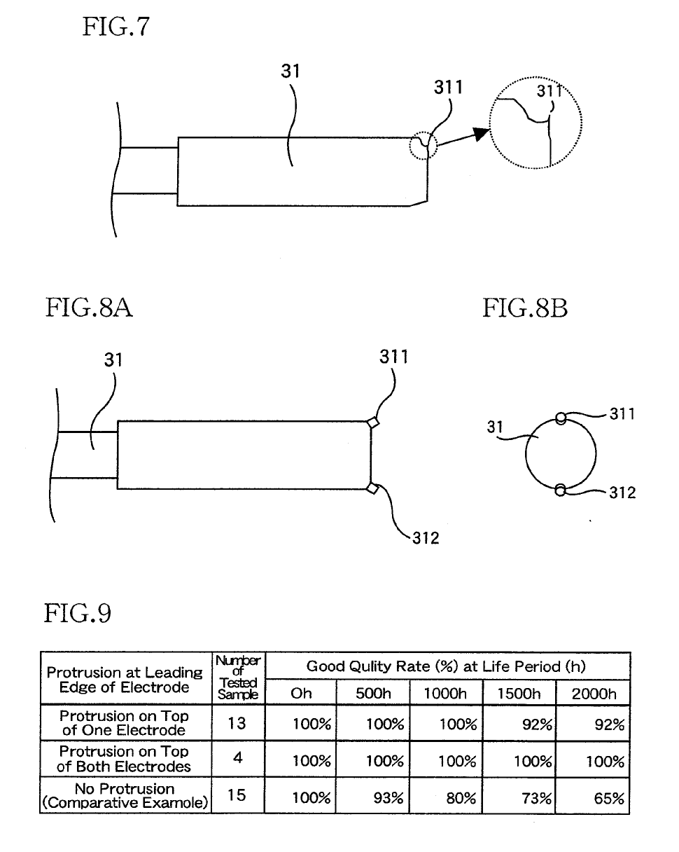

FIG. 7 is an enlarged view for explaining an electrode according to a second embodiment of the present invention. Same portions with those of the metal halide lamp shown in FIG. 1 are assigned with the same symbols and the explanation is omitted. In the second embodiment, a sharp protrusion 311 (321) is formed on an upper portion of an leading end surface by forming a notch on the upper leading end portion of the electrode 31 (32). Namely, a first protrusion 311 (321) having relatively small size compared with the diameter of the electrode 31 (32) is formed in the leading end portion of the electrode 31 (32) at a position where arc is produced during lighting of the lamp. With even such a protrusion, the similar advantages can be obtained to those described in the description of the first embodiment.

The first protrusion 311 (321) in the present embodiment is formed by aging with a relatively high electric power of 75 W or more supplied from the lighting circuit. The dimension of the protrusion 311 thus formed is preferable in the range 0.01 mm to 0.1 mm. The size of the protrusion can be varied by such aging conditions as an input electric power, a supply hour and the like. Here, a protrusion projecting over the leading end surface, or a protrusion not projecting over the leading end surface may be formed.

For this reason, similar advantages can be obtained in the metal halide lamp according to the present embodiment to those obtained in the first embodiment.

### Third Embodiment

FIG. 8A and FIG. 8B are enlarged views for showing an electrode according to a third embodiment of the present invention. In the figures, same portions of the metal halide lamp as those shown in FIG. 1 are assigned with the same symbols and the explanation is omitted. In the third embodiment, a second protrusion 312, (322) is formed on a lower portion of electrode 31, (32), in addition to the first protrusion 311, (321), formed on an upper portion of the electrode.

FIG. 9 is a table listing a good-quality rate relating to the flickering in the life period with the protrusion on a top and a bottom portion of the electrode of the metal halide lamp according to the lamp specification shown in FIG. 3. For the comparison purpose, tests were performed using samples with protrusions on the top and the bottom of one of a pair of electrodes, samples with protrusions on the top and the bottom of both electrodes, and samples with no protrusions. The test conditions etc. are similar to those in the case shown in FIG. 4.

A result is obtained that the flickering can be prevented from occurring for a long period when the protrusions are formed on the top and the bottom of the electrode, similar to the result shown in FIG. 4, in which the protrusion is formed only on the top portion.

Moreover, it is confirmed that in the lamp with the protrusions formed on the top and the bottom of the electrode, a start-up voltage is lowered and the start-up characteristics of the lamp is improved. To be more precise, the start-up voltage is 13.9 kV in a lamp with the protrusions formed on the top and the bottom of one of the electrodes, and is 13.4 kV in the lamp with the protrusions formed on the top and the bottom of the both electrodes, showing great improvement compared with 16.8 kV in a lamp having an electrode with no protrusion. This can be explained that a creeping discharge is generated by the bottom protrusion 312, 322, which causes another discharge through the discharge medium accumulated at a lower portion of the discharge space 13, thereby further decreasing the start-up voltage.

Thus, the similar advantages can be obtained in the metal halide lamp according to the embodiment to those in the first embodiment, and even further advantages can be obtained than that of the first embodiment.

### Fourth Embodiment

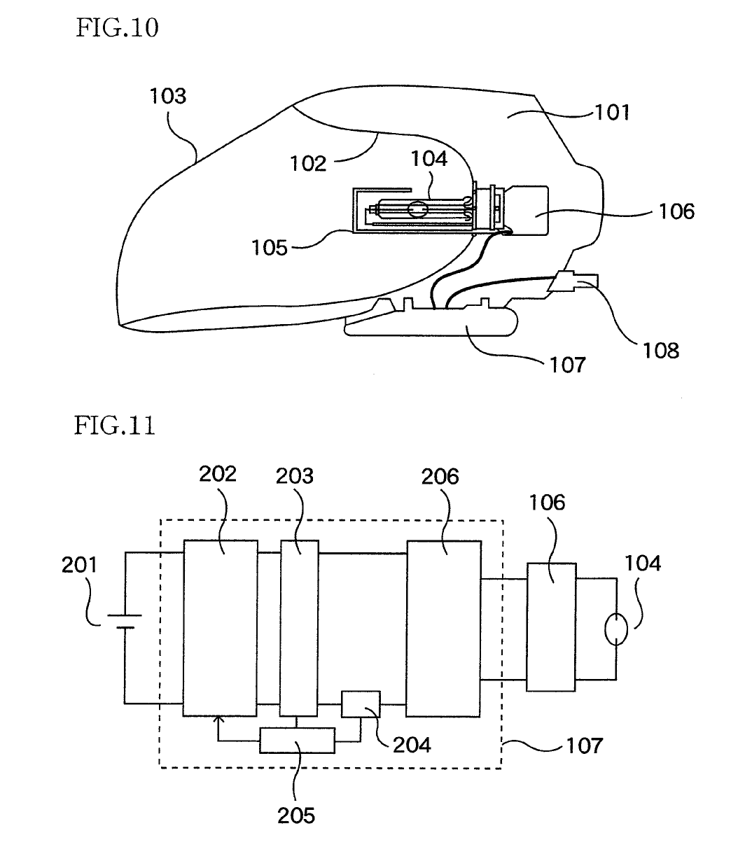

FIG. 10 is a view explaining the lighting device according to a fourth embodiment of the present invention. The lighting device is composed of a lighting device main body 101, a reflector 102, a front lens 103, a lamp 104, a shade 105, an igniter 106, ballast 107 and an external connecting terminal 108, where the later three components compose a lighting circuit.

In the main body 101, a hemispherical reflector 102 is provided and a front lens 103 is provided at light emitting portion. A lamp 104 is located nearly at central portion of the reflector 102 for emitting the light efficiently and for controlling light distribution. In front of the lamp 104, the shade 105 is provided for preventing deterioration of light distribution characteristics.

The lamp 104 is connected mechanically and electrically by fitting the socket 6 in an opening of the igniter 106. The igniter 106 is connected with the ballast 107 via a lead wire. The ballast 107 is connected with the external connecting terminal 108 for connecting electrically with an automobile via lead wire.

Here, the lighting circuit is explained referring to a circuit diagram shown in FIG. 11. The lighting circuit is composed of the ballast 107 and the igniter 108, an electric power is supplied to the lamp 104, which is supplied from a power source 201 composed of automobile battery of ten and a few Volts to several tens Volts, for example.

The ballast 107 includes a DC-DC converter 202, a voltage detection circuit 203, a current detection circuit 204, a comparison circuit 205, and a DC-AC inverter 206. The DC-DC converter 202 is mainly composed of a step-up chopper circuit having switching elements, transformers, diodes and other parts, in which a power source 201 is connected to an input side and the DC-AC inverter 206 composed of a bridge circuit having a plurality of switching elements is connected with the output side. Between the DC-DC converter 202 and the DC-AC inverter 206, the voltage detection circuit 203 is connected in parallel, and the current detection circuit 204 is connected in series. Since these detection circuits are provided for controlling the output of the DC-DC converter 202, the comparison circuit 205 is connected with the output side as a feedback circuit and the output of the comparison circuit 205 is supplied to the base of the switching element of the DC-DC converter 202.

The igniter 106 includes capacitors and coil transformers, in which an input side is connected with the DC-AC inverter 206 and an output side is connected with the lamp 104.

In the next, operation of the circuit will be explained. Electric power from the power source 201 is boosted by the DC-DC converter 202, and an output signal is detected by the voltage detection circuit 203 and by the current detection circuit 204. The detected result is feed backed to the switching elements of the DC-DC converter 202 through the comparison circuit 205, so that the output level is adjusted. After having been controlled to a desired level of electric power, the output of the DC-DC converter 202 is converted into AC by the DC-AC inverter 206, and is supplied to the igniter 106. In the igniter 106, electric charge is accumulated by the capacitor so as to apply a voltage of 15 kV or higher which is a dielectric breakdown voltage of the lamp 104. When the voltage reaches sufficient level, the voltage is applied on the lamp 104 at once and causes dielectric breakdown. After that, the power supply is so controlled that electric power of about 70 W is kept applying for several seconds to speed up an initial rise of light flux of the lamp 104, then, the electric power gradually approaches to the rating power.

Therefore, a lighting device is provided which is able to inhibit the generation of the flickering for a long period.

1. A metal halide lamp comprising:
a translucent and airtight vessel having a light emitting tube portion forming a discharge space and sealing portions formed on both ends of the light emitting tube portion;
a discharge medium composed of metal halide and rare gas enclosed in the discharge space and essentially containing no mercury;
a pair of electrodes each having a base end and a leading end, the base end portion being sealed in the sealing portion and the leading end portion being so arranged to face the leading end portion of another electrode in the discharge space, and the pair of electrodes being composed of tungsten containing electron emitting material; and
a first protrusion provided on the leading end portion of at least one of the pair of the electrodes at a position where arc is generated during lighting.

2. The metal halide lamp according to claim 1, wherein weight ratio of the electron emitting material contained in the electrode is from 0.1 wt. % to 1.2 wt. %.

3. The metal halide lamp according to claim 2, wherein the electron emitting material is thorium oxide.

4. The metal halide lamp according to claim 3, wherein the first protrusion has a size of 20% or less of the diameter of the leading end of the electrode and is formed on an upper portion of the leading end portion of the electrode.

5. The metal halide lamp according to claim 4, wherein the first protrusion is composed of essentially the same material as the material composing the electrode.

6. The metal halide lamp according to claim 5, wherein the first protrusion is formed on both electrodes of the pair of electrodes and a distance between the electrodes, which is a distance between the first protrusions in the discharge space is 5 mm or less.

7. The metal halide lamp according to claim 6, wherein the distance between the electrodes is from 3.5 mm to 5.0 mm.

8. The metal halide lamp according to claim 1, wherein the electrode is provided with a second protrusion formed on a lower portion of the leading end portion.

9. The metal halide lamp according to claim 2, wherein the electrode is provided with a second protrusion formed on a lower portion of the leading end portion.

10. The metal halide lamp according to claim 3, wherein the electrode is provided with a second protrusion formed on a lower portion of the leading end portion.

11. A lighting device comprising:
a lighting device main body;
a metal halide lamp arranged in the main body of the lighting device; and
a lighting circuit electrically connected with the metal halide lamp;
wherein the metal halide lamp further comprises:
a translucent and airtight vessel having a light emitting tube portion forming a discharge space and sealing portions formed on both ends of the light emitting tube portion;
a discharge medium composed of metal halide and rare gas enclosed in the discharge space and essentially containing no mercury;
a pair of electrodes each having a base end and a leading end, the base end portion being sealed in the sealing portion and the leading end portion being so arranged to face the leading end portion of another electrode in the discharge space, and the pair of electrodes being composed of tungsten containing electron emitting material; and
a first protrusion provided on the leading end portion of at least one of the pair of the electrodes at a position where arc is generated during lighting.

12. The lighting device according to claim 11, wherein the weight ratio of the electron emitting material contained in the electrode is from 0.1 wt. % to 1.2 wt. %.

13. The lighting device according to claim 12, wherein the electron emitting material is thorium oxide.

14. The lighting device according to claim 13, wherein the first protrusion has a size of 20% or less of the diameter of the leading end portion of the electrode and is formed on an upper portion of the lading end portion of the electrode.

15. The lighting device according to claim 14, wherein the first protrusion is composed of essentially the same material as the material composing the electrode.

16. The lighting device according to claim 15, wherein the first protrusion is formed on both electrodes of the pair of electrodes, and a distance between the electrodes, which is a distance between the first protrusions in the discharge space is 5 mm or less.

17. The lighting device according to claim 16, wherein the distance between the electrodes is from 3.5 mm to 5.0 mm.

18. The lighting device according to claim 11, wherein the electrode is provided with a second protrusion formed on a lower portion of the leading end portion.

19. The lighting device according to claim 12, wherein the electrode is provided with a second protrusion formed on a lower portion of the leading end portion.

20. The lighting device according to claim 13, wherein the electrode is provided with a second protrusion formed on a lower portion of the leading end portion.
